(19) United States
(12) Patent Application Publication
(10) Pub. No.: US 2017/0059489 A1
(43) Pub. Date: Mar. 2, 2017

(54) Method and Apparatus for Auditing the Cleaning of Surfaces

(71) Applicants: David Fleetwood, Corvallis, OR (US); Richard Nafshun, Corvallis, OR (US)

(72) Inventors: David Fleetwood, Corvallis, OR (US); Richard Nafshun, Corvallis, OR (US)

(21) Appl. No.: 14/843,759

(22) Filed: Sep. 2, 2015

(51) Int. Cl. G01N 21/88; G01N 21/33; C09K 3/30

(52) U.S. Cl. CPC G01N 21/8803; C09K 3/30; G01N 21/33; G01N 2201/061

(57) ABSTRACT

A cleaning audit solution that allows a user to determine how well a surface has been cleaned is provided herein. Embodiments of the present invention are used to determine the effectiveness or proficiency of cleaning activities performed on a surface. Embodiments of the present invention are mixtures that are be sprayed on a wide variety of surface types; the embodiments remaining invisible to the naked eye until exposed to ultraviolet light. If, after cleaning activities have been performed, a substantial amount of the present invention remains on a surface, the effectiveness of the cleaning activity is substandard. However, if very little or none of the present invention can be seen on a surface after cleaning, the effectiveness of the cleaning is high.

### BACKGROUND OF THE INVENTION

The present invention relates to monitoring and auditing cleaning activities, and more specifically, to monitoring and auditing methods and solutions which employ visual aids for ensuring cleanliness within a plurality of environments.

### FIELD OF THE INVENTION

Disinfected environments and surfaces within, but not limited to, the medical field, laboratory settings, or hospitality services are preferred to prevent contamination or the spread of disease. Unfortunately, it has become increasingly difficult to ensure proper cleansing of all surfaces, and as such, lack of sanitation has resulted in an increase in the amount of contact, and subsequent spread of pathogens throughout the population.

Of the many methods for measuring cleanliness, three basic tools or methods fall into the realm of sustainable monitoring. They include direct practice observation, adenosine triphosphate (ATP) bioluminescence systems and fluorescent gel monitoring. Each of these methods has merit and each has its place in the hospital setting based on personnel, budgets, availability and other factors.

In direct practice observation, an appointed member of a location's staff, generally management, observes the cleaning of surfaces or does a visual inspection after an area has been completely cleaned. This can be evaluated statistically by use of a visual checklist to quantify results. The problem with this method is that it is very subjective, as one supervisor may have different standards of what they would consider to be sufficiently disinfected than another supervisor. Additionally, they may have biases such as past experience, which may skew results. This also means that direct observation results cannot be reliably reproduced between quality inspectors from day to day or even throughout a 24-hour period. This method also requires additional staff to be on roster for evaluations.

ATP systems have been used in the food service industry for about 30 years. These systems measure the amount of surface contamination present on objects. ATP monitors express the amount of bioburden on a surface in a measure called relative light units (RLUs) by taking a swab culture of environmental surfaces.

This method is advantageous from a personnel stance in that the level of cleanliness can be measured objectively, which takes most human influences or preconceptions out of the decision and can produce reliable, reproducible results given correct circumstances. As serious deficiency of ATP monitoring is that there are no consistently accepted or published standards about which RLU measurement benchmark equates to a clean and disinfected surface.

Unfortunately, without a structured and audited training and monitoring program to teach quality-assurance staff how large an area to culture swab and how to use the monitoring device properly, results can be skewed. Furthermore, each reading takes roughly thirty seconds and involves swabbing the surface in question and inserting the swab into the monitoring device to be read. This can become very labor intensive, as it is not uncommon to monitor ten to twenty surfaces in a single room.

Fluorescent gel monitoring involves the application of an invisible fluorescent mark on a random sampling of environmental surfaces prior to disinfecting and then returning afterwards to ensure the mark has been removed through a combination of the mechanical and chemical process of cleaning.

These gels are generally invisible unless placed under an ultraviolet light. The material within the gel absorbs the UV light and emits photons within the visible spectrum, allowing the user to clearly see the mark. The UV-reacting material is then broken apart by disinfecting agents, and can no longer be detected once a UV light is used on the surface, indicating a sufficiently-disinfected environment.

This method is a less-technical way to monitor whether surfaces have been sufficiently disinfected and is vastly less time and labor-intensive than ATP monitoring. Each mark takes a negligible amount of time to place on a given surface and check after cleaning. If the mark has been effectively removed, and the auditor has varied the locations on which the marks are placed, the auditor can be reasonably assured the surface or room has been thoroughly disinfected.

There are limitations to this method as well, such as the challenge of clandestinely placing the marks on surfaces without the knowledge of cleaning staff If a technician sees an auditor enter the room in question, he or she likely will know the room is being monitored and then may clean that room differently, falsely, thereby enhancing results. The gel markers used for this method are also handicapped by the ability to only leave small marks within a large area, and can leave larger surfaces unable to be guaranteed as fully disinfected.

Aerosol devices are known within the art. An aerosol device used for the application of liquids employs a pressurized container and a user-activated release valve. Once the valve is opened, the pressure difference between the inside of the device and the outer environment causes the contents within the device to move to the area with the lowest pressure. This device is the preferred method for materials which require a misting pattern for greater coverage of areas in a shorter period of time.

It could be said there lies a need for a method to audit preferably-disinfected surfaces and environments employing an ultraviolet marking system which is able to cover larger surfaces.

The present invention meets this need by providing the user with an ultraviolet marking spray which is applied via an aerosol-based device.

### BRIEF SUMMARY OF THE INVENTION

The present invention provides a cleaning audit solution that allows a user to determine how well a surface has been cleaned. The user can utilize embodiments of the present invention to determine the effectiveness, or proficiency, of cleaning activities performed on a surface. Embodiments of the present invention are mixtures that can be sprayed on a wide variety of surface types; the embodiments remaining invisible to the naked eye until exposed to ultraviolet light. If, after cleaning activities have been performed, a substantial amount of the present invention remains on a surface, the effectiveness of the cleaning activity can be considered insufficient. However, if very little or none of the present invention can be seen on a surface after cleaning, the effectiveness of the cleaning can be considered sufficient.

Embodiments of the present invention are dispersed from an aerosol container to allow for quick and easy cleaning audits. A user simply needs to spray an embodiment of the present invention on a surface then wait for cleaning to be performed. After the cleaning is performed, the user can shine a black light or ultraviolet light on the surface to determine if it has been properly cleaned. Embodiments of the present invention do not stain a surface and, because of their composition, can be easily removed using common, general purpose cleaners.

Embodiments of the present invention generally comprise a mixture formed from a coloring agent that is mixed with a polymer or copolymer and a non-aqueous solvent. The mixture is stirred at heat until the components are fully dissolved. After full dissolution, the mixture is loaded into an aerosol or non-aerosol delivery device for use by a user that is performing a cleaning audit.

Other novel features which are characteristics of the invention, as to organization and method of operation, together with further and advantages thereof will be better understood from the following description considered in connection with the accompanying figures, in which preferred embodiments of the invention are illustrated by way of example. It is to be expressly understood, however, that the figures are for illustration and description only and are not intended as a definition of the limits of the invention. The various features of novelty which characterize the invention are pointed out with particularity in the following description. The invention resides not in any one of these features taken alone, but rather in the particular combination of all of its structures for the functions specified.

### BRIEF DESCRIPTION OF THE FIGURES

FIG. 1 illustrates the compounds of a cleaning audit solution as according to one embodiment of the present invention;

FIG. 2 illustrates the compounds of a cleaning audit solution as according to one embodiment of the present invention;

FIG. 3 illustrates the compounds of a cleaning audit solution as according to one embodiment of the present invention;

FIG. 4 illustrates the compounds of a cleaning audit solution as according to one embodiment of the present invention;

FIG. 5 is a flowchart of a method for formulating a cleaning audit solution as according to one embodiment of the present invention;

FIG. 6 is a flowchart of a method for formulating a cleaning audit solution as according to one embodiment of the present invention;

FIG. 7 is a flowchart of a method for formulating a cleaning audit solution as according to one embodiment of the present invention;

FIG. 8 is a flowchart of a method for formulating a cleaning audit solution as according to one embodiment of the present invention; and

FIG. 9 is a flowchart of a cleaning audit process.

A further understanding of the present invention can be obtained by reference to a preferred embodiment set forth in the accompanying description. Although the illustrated embodiments are merely exemplary of methods for carrying out the present invention, both the organization and method of operation of the invention, in general, together with further objectives and advantages thereof, may be more easily understood by reference to the illustrations and the following description. The figures are not intended to limit the scope of this invention, but merely to clarify and exemplify the invention.

### DETAILED DESCRIPTION OF THE INVENTION

In the following detailed description, reference is made to specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the terms “embodiment(s) of the invention”, “alternative embodiment(s)”, and “exemplary embodiment(s)” do not require that all embodiments of the method(s) or apparatus include the discussed feature, advantage or mode of operation. The following description of the preferred embodiment is merely exemplary in nature and is in no way intended to limit the invention, its application, or use.

There has thus been broadly outlined the more important features of the invention in order that the detailed description thereof that follows may be better understood, and in order that the present contribution to the art may be better appreciated. There are, of course, additional features of the invention that will be described hereinafter and which will form additional subject matter. Those skilled in the art will appreciate that the conception upon which this disclosure is based may be readily utilized as a basis for the designing of other structures, methods and systems for carrying out the purposes of the present invention. It is important, therefore, that any embodiments of the present invention be regarded as including such equivalent constructions insofar as they do not depart from the spirit and scope of the present invention.

Further, the purpose of the Abstract herein is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the invention of this application nor is it intended to be limiting as to the scope of the invention in any way.

Referring now to the present invention, there is introduced a cleaning audit solution comprised of a coloring agent, a polymer or copolymer, and a non-aqueous solvent that is used to determine the effectiveness of the cleaning of a surface. For the purpose of clarity, all like elements mentioned in this description will have the same designations. The terms “cleaning audit solution”, “audit solution”, “solution”, “mixture”, “invention”, and “present invention” may be used interchangeably. In addition to the functions, features, components, and abilities of the invention already discussed in this specification, the invention may also have, but not be limited to, the following features contained within the description below.

The present invention solves the shortcomings of the prior art by providing a cleaning audit solution that allows a user to quickly and easily determine whether the cleaning of surfaces within an area has been effectively performed. The preferred embodiments described below set forth the present invention in greater detail.

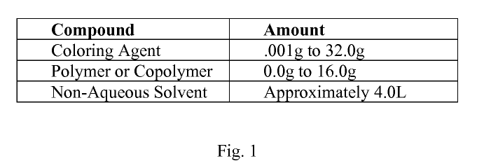

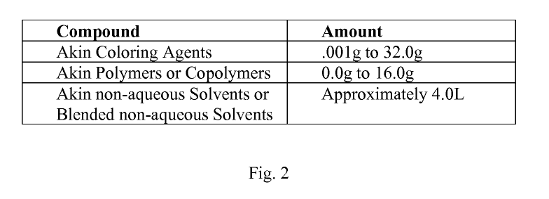

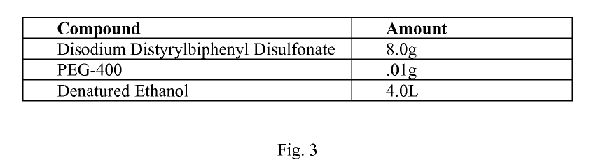

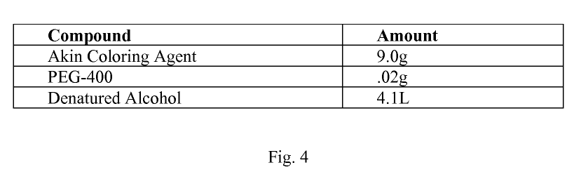

Referring now to FIGS. 1-4 that will be discussed together, there are shown tables of compounds and the amounts of those compounds that are used in embodiments of the present invention. Embodiments of the present invention generally comprise proportional ratios of the illustrated amounts of the compounds illustrated in FIGS. 1-4. Thus, it is not necessary for an embodiment of the present invention to contain the same amounts of the compounds as illustrated in FIGS. 1-4, but only need contain the proportional equivalents of those amounts. By way of example, an embodiment of the present invention contains 0.001 g (grams) to 32.0 g of a coloring agent, 0.0 g to 16.0 g of a polymer or copolymer and 4.0 L (liters) of a non-aqueous solvent. Another embodiment of the present invention contains 1.0 kg (kilograms) to 32.0 kg of a coloring agent, 0.0 kg to 16.0 kg of a polymer or copolymer and 4.0 kl (kiloliters) of a non-aqueous solution.

In the embodiment of the present invention that comprises between 0.001 g and 32.0 g of a coloring agent, between 0.0 g and 16.0 g of a polymer or copolymer and approximately 4.0 L of a non-aqueous solvent, the coloring agent is the component of the solution that is visible to a user only when exposed to ultraviolet light. It is not visible when exposed to light wavelengths falling within the visible spectrum, about 390 nm (nanometers) to 700 nm. For purposes of this disclosure, ultraviolet light is considered to be light with a wavelength of 100 nm to 400 nm. Light in the ultraviolet spectrum has a wavelength that is too short to cause a response in the human eye. That is ultraviolet light does not cause rods or cones within the human eye to fire.

A number of similar reagents can be used as the coloring agent of the present invention. In one embodiment of the present invention, the coloring agent is disodium distyrylbiphenyl disulfonate which is visible under light within the ultraviolet wavelength spectrum, but is not visible under light within the visible wavelength spectrum. In another embodiment of the present invention, the coloring agent is an akin (similar) coloring agent. The akin coloring agent is also visible under light within the ultraviolet wavelength spectrum, but is not visible under light within the visible wavelength spectrum.

The amount of the coloring agent used in embodiments of the present invention ranges from 0.001 g to 32.0 g per mixture of cleaning audit solution. In an embodiment of the present invention, 8.0 g of disodium distyrylbiphenyl disulfonate is used in the cleaning audit solution as the coloring agent. In another embodiment of the present invention, 9.0 g of an akin coloring agent is used in the cleaning audit solution as the coloring agent.

A number of akin reagents can be used as the polymer or copolymer. In one embodiment of the present invention, the polymer or copolymer is polyethylene glycol (PEG-400). PEG-400 is a very hydrophilic reagent that has the characteristics of being clear, colorless and viscous. PEG-400 is readily soluble in a variety of alcohols including the alcohols or ethanol used as the non-aqueous solvent in embodiments of the present invention as discussed below. In another embodiment of the present invention, the polymer or copolymer is an akin polymer or copolymer. The akin polymer or copolymer is also readily soluble in the non-aqueous solvent. In yet another embodiment of the present invention, no polymer or copolymer is used.

The amount of the polymer or copolymer used in embodiments of the present invention range from 0.0 g to 16.0 g per mixture of cleaning audit solution. In an embodiment of the present invention, 0.1 g of PEG-400 is used in the cleaning audit solution as the polymer. In another embodiment of the present invention, 0.2 g of an akin copolymer is used in the cleaning audit solution as the copolymer. In yet another embodiment of the present invention, 0.0 g of polymer or copolymer is used.

A number of similar reagents can be used as the non-aqueous solvent. In one embodiment of the present invention, the non-aqueous solvent is denatured ethanol. Denatured ethanol is a methylated spirit that has additives added to it that prevent its consumption by humans. The denatured ethanol is the compound of the invention that dissolves the coloring agent and the polymer or copolymer, in embodiments utilizing a polymer or copolymer. The dissolution of the other components of the present invention allow for the creation of the cleaning audit solution. In another embodiment of the present invention, the non-aqueous solvent is an akin non-aqueous solvent. The akin non-aqueous solvent readily dissolves the coloring agents and, if used, the polymer or copolymer.

The amount of the non-aqueous solvent used in embodiments of the present invention is approximately 4.0 L per mixture of cleaning audit solution. In an embodiment of the present invention, 4.0 L of denatured ethanol is used in the cleaning audit solution as the non-aqueous solvent. In another embodiment of the present invention, 4.1 L of denatured alcohol is used in the cleaning audit solution as the non-aqueous solvent. In yet another embodiment of the present invention, 4.0 L of an akin non-aqueous solvent is used.

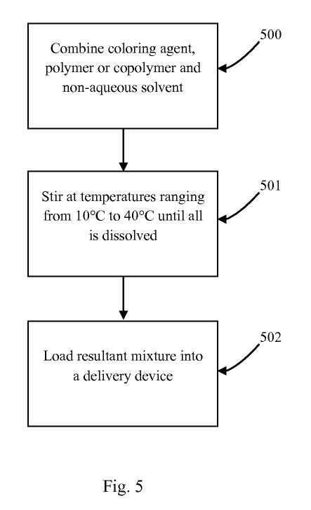

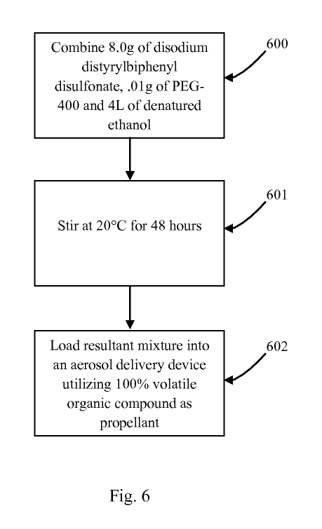

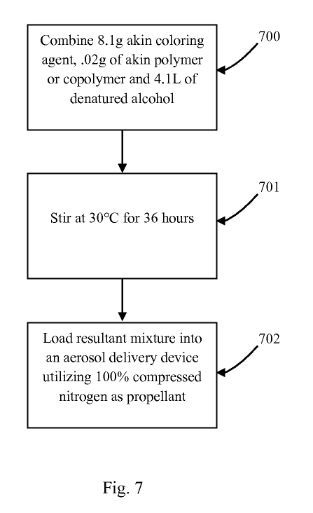

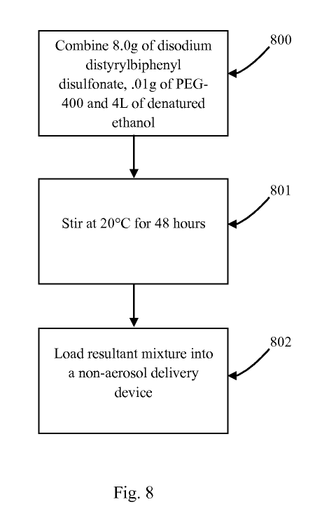

Referring now to FIGS. 5-8 that will be discussed together, there are flowcharts denominating methods for formulating cleaning audit solutions as according to embodiments of the present invention. The methods for formulating the cleaning audit solutions generally comprise combining a coloring agent with a polymer or copolymer in a non-aqueous solvent (500). It is important to note that although not pictured, some embodiments of the present invention comprise combining only the coloring agent in a non-aqueous solvent.

The combination of the coloring agent; polymer or copolymer, if used; and the non-aqueous solvent is stirred at a temperature ranging from 10° C. to 40° C. for a period of time until the all of the compounds are dissolved (501). This time period can be relatively short, from several minutes, to relatively long, several days, depending on the compounds used and their rate of dissolution. The resultant dissolved mixture is inserted into a delivery device (502). Once inserted into the delivery device, the present invention can be used by a user to audit the effectiveness of cleaning activities performed on a surface.

In an embodiment of the present invention, 8.0 g of disodium distyrylbiphenyl disulfonate is combined with 0.01 g of PEG-400 in 4.0 L of denatured ethanol (600). The reagents are stirred at 20° C. for 48 hours (601). Stirring the mixture at 20° C. for 48 hours (601) causes the compounds to fully dissolve within the denatured ethanol. The dissolved mixture is then loaded into an aerosol delivery device, such as an aerosol can, that utilizes 100% volatile organic compounds (VOCs) as the propellant (602).

In some embodiments of the present invention, such as those that utilize aerosol cans as the delivery device, the delivery device is pressurized with propellants so that the cleaning audit solution can be quickly and easily distributed over the surface that a user wishes to monitor for cleaning effectiveness. In other embodiments of the present invention, such as those utilizing a manual spray bottle, the delivery device is not pressurized because the manual actuation of the spray mechanism causes the cleaning audit solution to be quickly and easily distributed over the surface that a user wishes to monitor for cleaning.

In another embodiment of the present invention, 8.1 g of an akin coloring agent is combined with 0.02 g of an akin polymer or copolymer, if used, in 4.1 L of denatured alcohol (700). The reagents are stirred at 30° C. for 36 hours (701). Stirring the mixture at 30° C. for 36 hours (701) causes the compounds to fully dissolve within the denatured alcohol. The dissolved mixture is then loaded into an aerosol delivery device, such as an aerosol can, that utilizes 100% compressed nitrogen as the propellant (702).

In yet another embodiment of the present invention, 8.0 g of disodium distyrylbiphenyl disulfonate is combined with 0.01 g of PEG-400 in 4.0 L of denatured ethanol (800). The reagents are stirred at 20° C. for 48 hours (801). Stirring the mixture at 20° C. for 48 hours (801) causes the compounds to fully dissolve within the denatured ethanol. The dissolved mixture is then loaded into a non-aerosol delivery device, such as a container with a hand-operated spray nozzle (802).

Delivery devices, as used in embodiments of the present invention, are containers that allow for a user to transport the cleaning audit solution to locations where a cleaning audit is to be performed. Delivery devices include, but are not limited to: aerosol cans; spray bottles; handheld metal cans, metal bottles, plastic cans, plastic bottles; containers with hand or finger operated spray nozzles; and the like. It is important to note that the delivery device, as used in embodiments of the present invention, is not limited in scope to the apparatus as mentioned in this disclosure, but includes those devices that provide easy transport of the cleaning audit solution to a cleaning audit location.

Cleaning audits, for which embodiments of the present invention have been formulated, is the process of determining the effectiveness of cleaning activities. Cleaning audits can occur in institutions such as hospitals or prisons where a supervisor wishes to evaluate the effectiveness of the janitorial service. Cleaning audits can also occur in the hospitality services such as a motel where the manager wishes to evaluate the effectiveness of the housekeeping staff A cleaning audit can be performed with or without the knowledge of the person being audited.

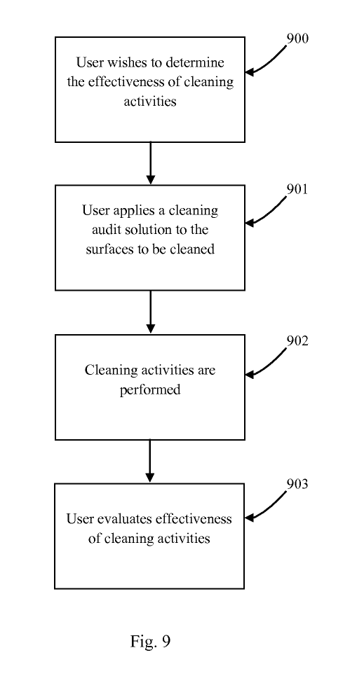

Referring now to FIG. 9, a cleaning audit occurs when a user, such as a manager or a supervisor, wishes to determine the effectiveness of cleaning activities (900). The user applies a cleaning audit solution, an embodiment of the present invention, to the surfaces in an area to be cleaned (901). The area to be cleaned can include, but is not limited to, a hotel room, a hospital room, a bathroom, a prison cell, and the like. Cleaning activities are performed (902) in the area where the cleaning audit solution has been applied. Because the cleaning audit solution is visible only under ultraviolet light, the person or group of people performing the cleaning activities are not aware of the location of the cleaning audit solution. They may or may not be aware that the cleaning audit solution has been applied to the surfaces in the area where they are to clean (901). Embodiments of the present invention are formulated so that they are undetectable under light in the visible wavelengths. The embodiments are not just transparent, transparency alone would allow the person being audited to detect a sheen or film caused by the application of the audit solution over a surface, but are formulated to be non-detectable by the person being audited. That is, embodiments of the present invention has physical properties that prevent it from leaving visual traces such as sheens or films on a surface.

Embodiments of the present invention have been formulated so that if the cleaning activities are performed (901) efficiently, most or all of the cleaning audit solution will be easily removed from the surfaces to which it has been applied. The components that comprise embodiments of the present invention are easily removed from a surface by common surfactants including a wide variety of household and commercial cleaning agents.

The cleaning activities performed (902) by the person being audited can include, but are not limited to, the cleaning of a counter, the cleaning of a floor, washing or replacing bedding, washing or replacing towels, cleaning silverware or dishware, washing windows, cleaning carpets, and the like.

After the cleaning activities have been performed (902) a user can evaluate the effectiveness of the cleaning activities (903). The user that evaluates the effectiveness of the cleaning activities (903) may or may not be the same user that applied the cleaning audit solution to the surfaces to be cleaned (901). The user evaluating the effectiveness of the cleaning activities (903) may be a user whose primary or sole responsibility is to evaluate cleaning activities and is most familiar with the evaluation process. The evaluation of the cleaning activities (903) can be performed by a user shining an ultraviolet light on the surfaces in the area where the cleaning audit solution was applied (901). The remaining cleaning audit solution will become visible under the ultraviolet light. Generally, the more cleaning audit solution remaining after the cleaning activities were performed (902), the less effective the cleaning activities were. This is because had the cleaning activities been effective, the activities would have removed more of the present invention from the surfaces being cleaned.

Embodiments of the present invention have been formulated to work on a plurality of surface types. The surface types that embodiments of the present invention can be used on include, but are not limited to: non-porous, porous, linen, finished wood surfaces, and the like.

There are described and illustrated new and improved cleaning audit solutions, and methods for formulating the cleaning audit solutions. The inventive portions of the method and solutions for auditing the cleaning of surfaces include several compounds and steps that, when taken together, constitute an embodiment of the present invention. The above detailed description sets forth rather broadly the more important features of the present invention in order that its contributions to the art may be better appreciated.

As such, those skilled in the art will appreciate that the conception, upon which disclosure is based, may readily be utilized as a basis for designing other structures, methods, and systems for carrying out the several purposes of the present invention. It is important, therefore, that this description be regarded as including such equivalent constructions insofar as they do not depart from the spirit and scope of the present invention.

Although certain example methods, solutions, apparatus and articles of manufacture have been described herein, the scope of coverage of this application is not limited thereto. On the contrary, this application covers all methods, apparatus and articles of manufacture fairly falling within the scope of the invention either literally or under the doctrine of equivalents.

Directional terms such as “front”, “forward”, “back”, “rear”, “in”, “out”, “downward”, “upper”, “lower”, “top”, “bottom”, “upper”, “lower” and the like may have been used in the description. These terms are applicable to the embodiments shown and described herein. These terms are merely used for the purpose of description and do not necessarily apply to the position in which components or items within the present invention may be used.

Therefore, the foregoing is considered as illustrative only of the principles of a cleaning audit solution. Further, since numerous modifications and changes will readily occur to those skilled in the art, it is not desired to limit the cleaning audit solution to the exact construction and operation described, and accordingly, all suitable modifications and equivalents may be resorted to, falling within the scope of the present invention. While the above description describes various embodiments of the present invention, it will be clear that the present invention may be otherwise easily adapted to fit other configurations.

As various changes could be made in the above constructions without departing from the scope of the invention, it is intended that all matter contained in the above description shall be interpreted as illustrative and not in a limiting sense.

We claim:

1. A solution for auditing cleaning activities performed on a surface comprising:
a coloring agent;
a polymer or copolymer;
a non-aqueous solvent;
wherein the coloring agent and the polymer or copolymer are completely dissolved in the non-aqueous solvent; and the coloring agent, polymer or copolymer, and non-aqueous solvent are loaded into a delivery device.

2. The solution of claim 1, wherein the amount of coloring agent ranges between 0.001 g to 32.0 g.

3. The solution of claim 1, wherein the amount of polymer or copolymer ranges between 0.0 g to 16.0 g.

4. The solution of claim 1, wherein the amount of non-aqueous solvent is 4.0 L.

5. The solution of claim 1, wherein the delivery device is an aerosol can.

6. The solution of claim 5, wherein the delivery device is pressurized.

7. The solution of claim 6, wherein the delivery device is pressurized with 100% volatile organic compounds.

8. A solution for auditing cleaning activities performed on a surface comprising.
disodium distyrylbiphenyl disulfonate;
polyethylene glycol 400;
denatured ethanol;
wherein the disodium distyrylbiphenyl disulfonate and the polyethylene glycol 400 are completely dissolved in the denatured ethanol; and the disodium distyrylbiphenyl disulfonate, polyethylene glycol 400, and the denatured ethanol are loaded into a delivery device.

9. The solution of claim 1, wherein the amount disodium distyrylbiphenyl disulfonate ranges between 0.001 g to 32.0 g.

10. The solution of claim 1, wherein the amount of polyethylene glycol 400 used ranges between 0.0 g to 16.0 g.

11. The solution of claim 1, wherein the amount of denatured ethanol used is 4.0 L.

12. The solution of claim 1, wherein the delivery device is an aerosol can.

13. The solution of claim 12, wherein the delivery device is pressurized.

14. The solution of claim 13, wherein the delivery device is pressurized with 100% volatile organic compounds.

15. A method for formulating a solution for the auditing of cleaning activities comprising:
creating a mixture by performing the following substeps:
a. adding a coloring agent to a non-aqueous solvent,
b. adding a polymer or copolymer to the non-aqueous solvent,
heating the mixture to a temperature ranging between 10° C. to 40° C.;
stirring the mixture until the coloring agent and polymer or copolymer have been completely dissolved; and
loading the mixture into a delivery device.

16. The method of claim 15, further comprising using disodium distyrylbiphenyl disulfonate as the coloring agent.

17. The method of claim 16, wherein the amount of disodium distyrylbiphenyl disulfonate used ranges from 0.001 g to 32.0 g.

18. The method of claim 15, further comprising using polyethylene glycol 400 as the polymer or copolymer.

19. The method of claim 18, wherein the amount of polyethylene glycol 400 used ranges from 0.0 g to 16.0 g.

20. The method of claim 15, wherein the delivery device is an aerosol can.
